(19) United States
(12) Patent Application Publication
(10) Pub. No.: US 2013/0140300 A1
(43) Pub. Date: Jun. 6, 2013

(54) MAGNETIC INDUCTION HEATER

(71) Applicant: Robert Paul Cummings, Huntsville, AL (US)

(72) Inventor: Robert Paul Cummings, Huntsville, AL (US)

(21) Appl. No.: 13/693,173

(22) Filed: Dec. 4, 2012

Related U.S. Application Data
(60) Provisional application No. 61/566,818, filed on Dec. 5, 2011.

(51) Int. Cl. H05B 6/02

(52) U.S. Cl. CPC H05B 6/02
USPC 219/672

(57) ABSTRACT

A magnetic induction heater uses a stationary target which is electrically conductive. A plurality of stationary magnets with fixed poles are positioned near the target to induce at least a first and a second magnetic field in the target, where the first and second magnetic fields are different. A shuttering device alternately blocks or allows the magnetic fields from the magnets to reach the target. The shuttering device is activated to alternately allow and block the first and second magnetic fields from the target, such that the target is exposed to varying magnetic fields to produce heat.

This non-provisional patent application claims priority to U.S. Provisional Patent Application No. 61/566,818, which was filed on Dec. 5, 2011.

### BACKGROUND OF THE INVENTION

a. Field of the Invention

The current invention relates to magnetic induction heaters.

b. Background of the Invention

Magnetic induction heaters have been used to heat electrically conductive objects (target object) for some time. In general, varying magnetic fields are induced in the target such that the magnetic field in the target changes. The varying magnetic field produces an electrical current within the target, and the heating results from eddy currents (which are also called Foucault currents) that are generated in the electrically conductive target object by changing the induced magnetic field within that target. This form of heating has been referred to as Joule heating. The eddy currents are formed by first inducing a magnetic field in the target object in a first direction, and then exposing the target to a different magnetic field in a second direction which is different than the first direction. This process is repeated to produce heat.

Several factors can impact the amount of heat produced. These factors include the strength of the magnetic field, the rate at which the magnetic field is changed, and the type of material the target object is made of. The strength of the magnetic field can depend on the overall strength of the magnet, the proximity of the magnet to the target, and the size and nature of other magnetic fields present. In general, stronger magnets will produce more heat than smaller magnets, and faster changes in the magnetic field will produce more heat.

Magnets have a north pole and a south pole, which is primarily just a way of referring to the opposite ends of a magnet. For example, many “U” shaped magnets have the north and south poles at the ends of the “U”, so the poles can be quite close together. Also, if you cut a magnet in half between the two poles, each half will have a north and a south pole. The north and south pole of a magnet are attracted together, and two North poles will repel each other. Two South poles will also repel each other.

Electric current passing through a coiled wire produces a magnetic field, as is understood by those skilled in the art. When some materials are exposed to a magnetic field, such as ferromagnetic materials, they will retain and display a persistent magnetic field even after being removed from the magnetic field. These types of materials can be used for permanent magnets. Other materials will only display magnetic properties while they are exposed to a magnetic field. These materials can act as a magnet when exposed to current through a coiled wire, and then become essentially non-magnetic when the current is stopped. Electromagnets often use a coiled wire, and the magnetism of some electromagnets can be effectively turned off and on.

A permanent magnet can be de-magnetized by several different techniques. For example, a permanent magnet can be demagnetized by heating it above its Curie temperature. Other steps that can either weaken or completely demagnetize a permanent magnet include: (i) placing the magnet in an alternating magnetic field with an intensity greater than the permanent magnet's coercivity, and then slowing decreasing the magnetic field to zero; (ii) place the permanent magnet in a reverse magnetic field with a strength greater than the permanent magnet's coercivity; (iii) exposing the permanent magnet to cyclic magnetic fields of sufficient strength; or (iv) sufficient impacts or jarring of the permanent magnet.

A magnetic field can be influenced by other magnetic fields. A magnetic field will tend to be drawn to another magnetic field of the opposite pole, or repelled by a magnetic field of the same pole. Therefore, a magnet's magnetic field will be influenced by other nearby magnetic fields. The lines of a magnetic field can be largely disrupted by placing the opposite pole of another magnet nearly.

A magnetic induction heater exposes a target to a varying magnetic field. Different methods and techniques can be use to vary the magnetic field. Heat transfer techniques and procedures can then be used to transfer the heat from the target, if desired. A technique which improves the efficiency or lowers the complexity of a magnetic induction heater can be useful for many applications.

### BRIEF SUMMARY OF THE INVENTION

A magnetic induction heater uses a stationary target which is electrically conductive. A plurality of stationary magnets with fixed poles are positioned near the target to induce at least a first and a second magnetic field in the target, where the first and second magnetic fields are different. These different magnetic fields induce eddy currents in the target. A shuttering device alternately blocks and allows the magnetic fields from the magnets to reach the target. The shuttering device is activated to alternately allow and block the first and second magnetic fields from the target, such that the target is exposed to varying magnetic fields to produce heat.

### BRIEF DESCRIPTION OF THE DRAWINGS

FIG. 1 is a side schematic view of one embodiment of the magnetic induction heater.

FIG. 2 is an exploded view of one embodiment of the magnetic induction heater.

FIG. 3 is a perspective view of another embodiment of the magnetic induction heater.

FIG. 4 is a perspective view of yet another embodiment of the magnetic induction heater.

FIG. 5 is a perspective view of a different embodiment of the magnetic induction heater.

FIG. 6 is a perspective view of still another embodiment of the magnetic induction heater.

### DETAILED DESCRIPTION

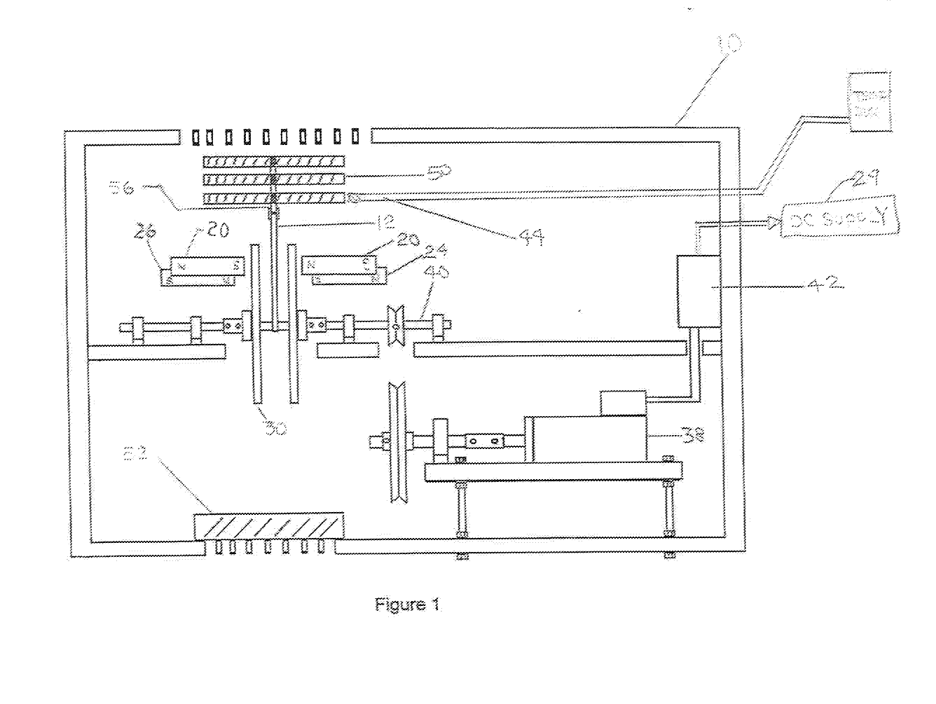

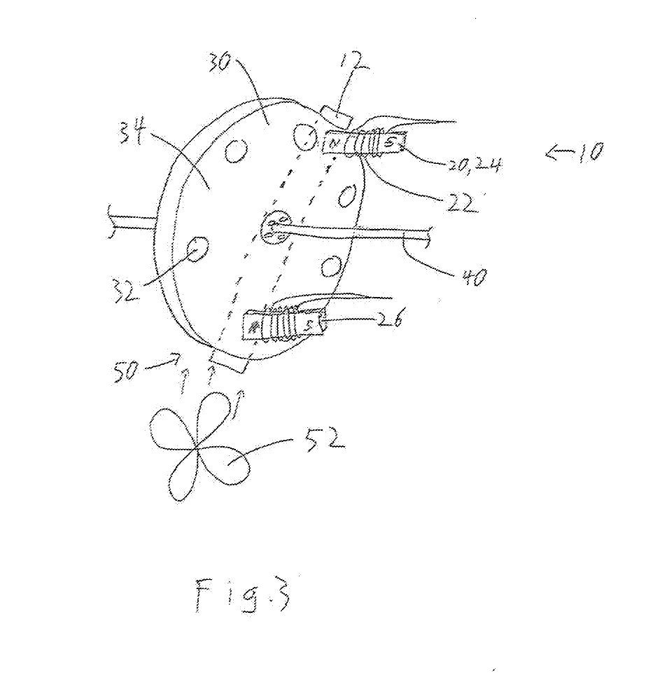

A magnetic induction heater 10, as seen in FIGS. 1-6, can be used to heat many things, including a living space, a particular object, or even a liquid. In this description, the magnetic induction heater 10 is primarily described for use to heat a living space.

### Target

The magnetic induction heater 10 includes a target 12, where the target 12 is an electrically conductive material. The target 12 is heated by successive exposure to varying magnetic fields, including at least a first and a second magnetic field. The changing magnetic fields produce eddy currents in the target, which are also called Foucault currents. The magnetic fields are different, so the induced eddy currents in the target 12 change as the target 12 is exposed to successive varying magnetic fields. As a non-limiting example, the first magnetic field may induce top to bottom eddy currents in the target 12, whereas the second magnetic field may induce bottom to top eddy currents in the target 12. The varying magnetic fields can be opposite each other, as just described, but it is also possible for the magnetic fields to vary in other ways, or for there to be more than two different magnetic fields.

The target 12 can be made of many materials, but the target should be electrically conductive. The materials in the target can include non-ferrous metals such as aluminum, copper, silver, or nickel. The target 12 can also be made of ferrous metals but the desired target material is preferably a non-ferrous metal, such as aluminum, copper, tin, brass, zinc or chrome.

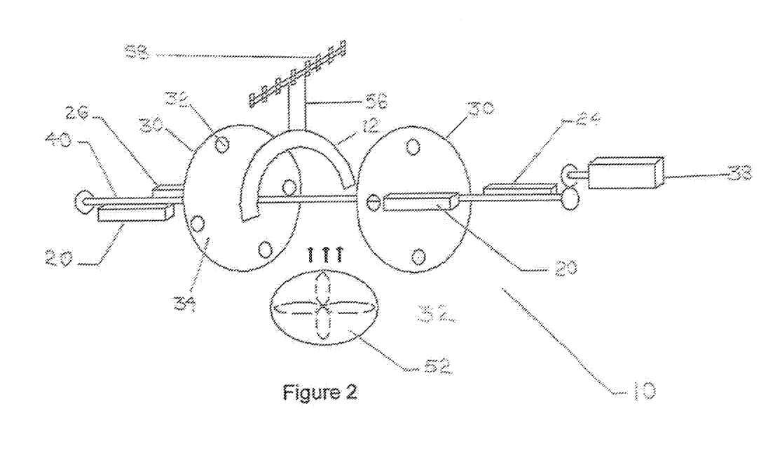

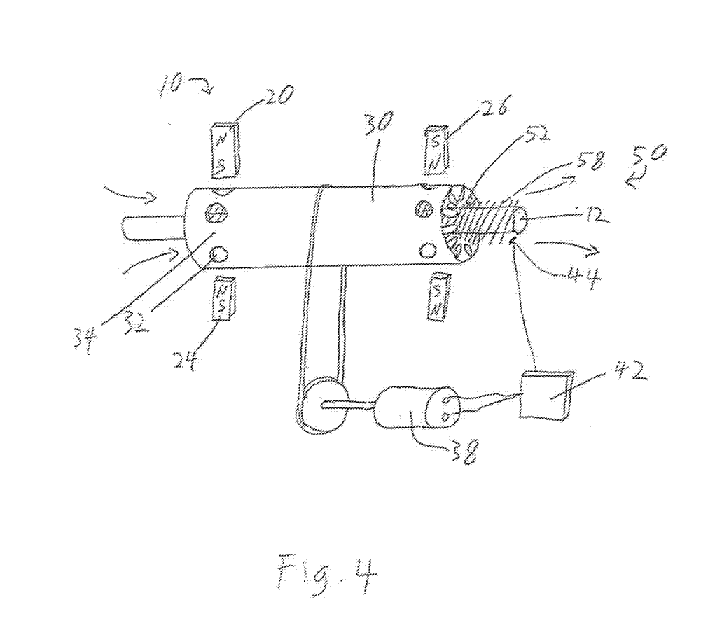

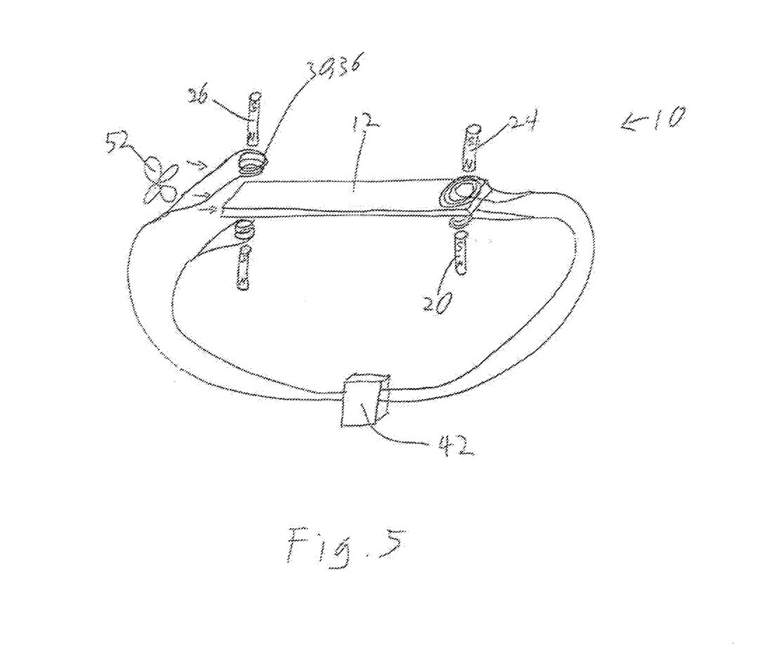

The target 12 can be many different shapes, and certain shapes are more amenable to different shaped magnetic inductive heaters 10. In one embodiment, the target 12 is essentially a curved rod, as seen in FIG. 2. In other embodiments, the target 12 can be a disc, a cylinder, a tube, or many other shapes, as seen in FIG. 4 or 5. Some target shapes can be interchanged in a single type of magnetic induction heater 10. For example, the target 12 in FIG. 1 could be a bar, an oval, a disc, or almost any shape with a relatively flat profile. The target 12 in FIG. 4 could be a cylinder or tube. In some embodiments, the target 12 will define a hole for other components of the magnetic inductive heater 10, such as a drive shaft. In still other embodiments, the target 12 may include a hole for air flow to facilitate heat transfer.

At this time, the target 12 has a fixed position in the magnetic inductive heater 10, such that the target 12 is stationary in use. This means the target 12 does not change positions within the magnetic inductive heater 10 while in operation. The entire magnetic inductive heater 10 may be portable, where every component in the magnetic inductive heater 10 moves together, but the target 12 does not move within the magnetic inductive heater during operation.

### Magnets

The magnetic induction heater 12 also includes a plurality of magnets 20, including at least a first magnet 24 and a second magnet 26. The magnets 20 have fixed poles, meaning the north pole of the magnet 20 is always the north pole, and does not alternate between being a north pole and a south pole. The poles of an electromagnet with alternating current will change, as opposed to the magnets 20 of the current invention with fixed poles. The magnet 20 may be an electromagnet, but any such magnet coil 22 will utilize direct current so that the poles of the magnet 20 remain fixed. The magnet 210 may also be a permanent magnet without a magnet coil 22, or a combination of a permanent magnet and an electromagnet.

The magnets 20 are positioned in close proximity to the target 12, such that the magnets 20 can induce a magnetic field within the target 12. This means the target 12 must be positioned within the magnetic field of the magnets 20, at least when there is nothing between the target 12 and the magnet 20. The magnets 20 may not actually touch the target 12, and the distance between the magnet 20 and the target 12 can depend on the strength of the magnet 20. In some embodiments, the magnets 20 are positioned near the end of the target 12, as opposed to a more central location.

The magnets 20 are stationary, such that the relative position of the magnets 20 and the target 12 do not change during the operation of the magnetic induction heater 10. The magnet 20 includes at least a first magnet 24 and a second magnet 26. The first and second magnets 24, 26 are positioned such that the first magnet 24 can induce a first magnetic field in the target 12, and the second magnet 26 can induce a second magnetic field in the target 12, where the first and second magnetic fields are different. This is generally accomplished by positioning the same pole of the first and second magnets 24, 26 at different positions relative to the target.

The first magnet 24 can include a plurality of magnets 20, preferably with opposite poles positioned near opposite ends of the target 12. This means a north pole would be positioned near one end of the target 12 and a south pole would be positioned near the opposite end of the target 12. The second magnet 26 can also include a plurality of magnets 20, preferably with opposite poles positioned near opposite ends of the target 12. Opposite poles positioned near opposite ends of the target 12 tend to induce a magnetic field along the entire length of the target 12, such that the target 12 will have an induced North and South pole on opposite ends of the target 12. This tends to produce an induced eddy current that spans the entire length of the target 12, as opposed to a more localized magnetic field on the target 12. A magnetic field that spans the entire length of the target 12 can increase the area where heat is generated when the induced eddy currents change.

In some embodiments, the first and second magnets 24, 26 are positioned to induce opposite eddy currents in the target 12. In other embodiments, there can be three or more sets of magnets positioned to induce three or more different eddy currents in the target 12, as desired. Different shaped targets 12 may benefit from different magnet 20 positioning strategies. There are many different possible positions for the various magnets 20 relative to the target 12.

The first magnet 24 can include several magnets 20 positioned at each end of the target 12, where the magnets 20 positioned on each end would preferably all have the same pole facing the target 20. Several magnets 210 working together can induce a stronger eddy current in the target 12, which can increase the amount of heat generated by the magnetic induction heater 10.

The magnets 20 car have different strengths, or the magnets 20 can all have essentially the same strength. The magnets 20 can be permanent magnets, or electromagnets, or both, and permanent and electromagnets can be used together in a single magnetic induction heater 10, if desired. It also possible for the first and second magnets 24, 26 to be positioned together, where the first magnet 24 is sufficiently stronger than the second 26 such that the first magnet 24 overpowers the second magnet 26 and thereby induces a different magnetic field in the target 12.

### Shuttering Device

The magnetic induction heater 10 also includes at least one shuttering device 30 positioned between the magnets 20 and the target 12. The shuttering device 30 is capable of blocking the magnetic field from the magnets 20, so the target 12 is not exposed to the full magnetic field of a magnet 20 while blocked by the shuttering device 30.

In some embodiments, the shuttering device 30 forms a physical barrier between the magnet 20 and the target 12. In these embodiments, the shuttering device 30 defines a passing gap 32 and a blocking section 34. The passing gap 32 is a hole or vacant space that allows the magnetic field from the magnet 20 to induce an eddy current in the target 12. The blocking section 34 is a solid section of the shuttering device 30 that interrupts the magnetic field, and at least partially shields the target 12 from the magnetic field of the magnet 20.

In some embodiments, the shuttering device 30 moves relative to the target 12 and the magnets 20 such that the passing gap 32 and the blocking section 34 are alternately positioned between the magnet 20 and the target 12. When the passing gap 32 is positioned between the magnet 20 and the target 12, the magnet 20 will induce an eddy current in the target 12. When the blocking section 34 is positioned between the magnet 20 and the target 12, the blocking section 34 blocks the magnetic field such that the magnet 20 does not induce an eddy current in the target 12, or at least induces a much weaker magnetic field than when the passing gap 32 is positioned between the magnet 20 and the target 12.

The passing gaps 32 and blocking sections 34 are positioned such that when the first magnet 24 is exposed to the target 12 by the passing gaps 32, the second magnet 26 is blocked from the target 12 by the blocking sections 34, and vice versa. If there are more than two different eddy currents induced in the target 12 by different magnets 20, the passing and block sections 32, 34 are positioned to block at least one of the magnetic fields from the target 12 while exposing the target to at least one of the magnetic fields.

The shuttering device 30 can be a disc with a plurality of holes positioned at a fixed radius from the center of the disc, as shown in FIGS. 1-3. The holes then serve as the passing gaps 32, and the solid material of the disc between the passing gaps 32 are the blocking sections 34. The magnets 20 are positioned adjacent to the target 12 such that the passing gaps 32 pass between the magnets 20 and the target 12 as the shuttering device rotates about its drive shaft 40, which can be positioned at the center point of the disc. In this manner, the induction heating device 10 has a stationary target 12 and magnets 20 (relative to each other) and the shuttering device 30 moves to alternately expose the target 12 to the first magnet 24 while blocking the magnetic field from the second magnet 26, and vice versa, thereby inducing varying magnetic fields in the target 12.

In embodiments where the blocking section 34 forms a physical barrier between the magnet 20 and the target 12, the shuttering device 30 is made of a material that blocks at least a substantial portion of the magnetic field from the magnets 20. This material should be a ferromagnetic material, such as low carbon steel. Ferromagnetic materials should be chosen that provide low residual magnetism with good permeability. Ferromagnetic materials seem to block the magnetic field quite well, and have been observed to generally work better than materials that are not ferromagnetic.

The shuttering device 30 can be many different shapes that alternately position the passing gaps 32 and the blocking sections 34 between the magnets 20 and the target 12. For example, the shuttering device 30 can be a disc, as seen in FIGS. 1-3, or a tube, as seen in FIG. 4. Many other shapes of magnetic induction heaters 110 are also possible. The shuttering device 30 can include a plurality of surfaces, such as a pair of discs positioned on each side of the target 12, as shown in FIGS. 1 and 2. The shuttering device 30 could be a plurality of plates on the end of shafts, similar to the blades of a fan. The shuttering device 30 could move back and forth with a cam-operated drive, or rotate about a central point, or any of a wide variety of other options that alternately expose the target 12 to the first and second magnet 24, 26 sets.

In an alternate embodiment, the shuttering device can be a plurality of blocking coils 36 positioned near the magnets 20 and the target 12 such that an induced magnetic field in the blocking coils 36 will interfere with the magnetic field from the magnets 20, as seen in FIG. 5. The induced magnetic field from the blocking coils 36 serves to shield the target 12 from the magnetic field of the magnet 12. The blocking coils 36 can be sized and wound such that a specified direct current will induce a magnetic field which largely blocks the magnets' 20 magnetic field from the target 12. In this embodiment, there are no moving parts, and direct current to the block coils 36 is alternately started and stopped to alternately pass and block the magnetic field from the magnets 20 to the target 12.

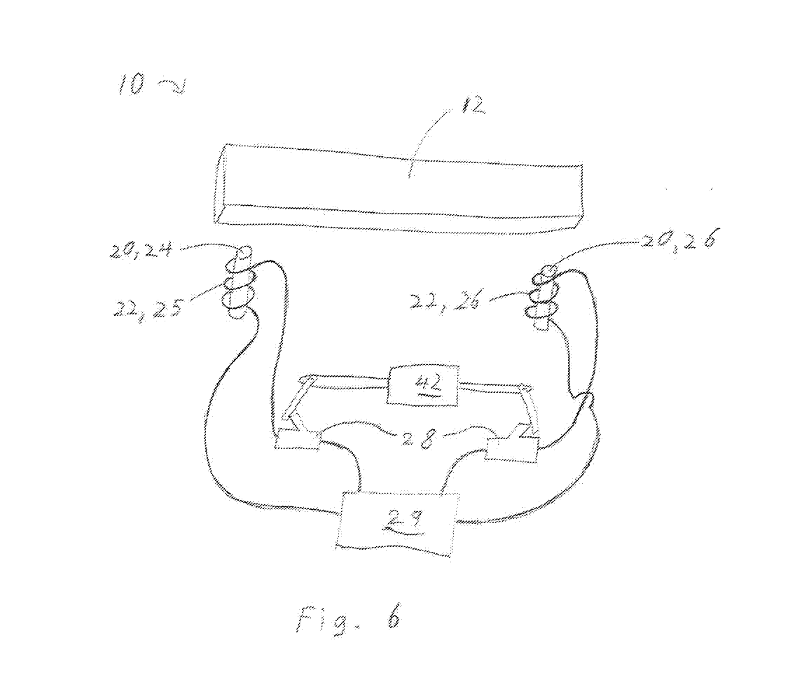

In yet another embodiment shown in FIG. 6, with continuing reference to FIGS. 1-5, the magnets 20 are electromagnets which do not have permanent magnetic cores. Therefore, in this embodiment, the magnets 20 will only project a magnetic field when current flows through the magnetic coils 22. Direct current is alternately started and stopped to the first and second magnets 24, 26, such that alternating magnetic fields are induced in the target 12. There are no moving parts in this embodiment either, and the poles of the magnets 20 remain fixed because direct current is used to power the magnetic coils 22. In all embodiments, the magnets and the target 12 are stationary, and the poles of the magnets 20 are fixed.

In this embodiment, the first magnet 24 has a first coil 25, and the second magnet 26 has a second coil 27. A switch 28 is connected to a direct current electricity supply 29, and the switch 28 is operated to alternately send direct current to the first and second coils 25, 27. The switch 28 can be a plurality of switches 28, or a single switch 28 could be used to send the direct current to the selected magnet 20. A controller 42 operates the switch 28 to alternately send direct current to the first and second coils 25, 27. In this embodiment, the magnet 20 should not be a ferrous material or other material that forms a permanent magnet, so the magnet 20 is not permanently magnetized by the coils 22. Because the magnets 20 are alternately started and stopped, alternating magnetic fields are induced in the target 12 which produces heat. The first and second coils 25, 27 serve to effectively “shutter” the first and second magnets 24, 26, so there is no requirement for an actual physical device to be located between the magnets 20 and the target 12.

### Drive

The shuttering device 30 moves relative to the magnets 20 and the target 12 in some embodiments, as seen in FIGS. 1-4. A drive 38 can be used to move the shuttering device 30. The drive 38 can be an electric motor, an internal combustion engine, or a wide variety of other drives 38. For example, the drive 38 could be connected to a stationary bike, so the magnetic induction heater 10 is human powered. The drive 38 could be connected to a water wheel, or to a windmill, or any other source of power that can be harnessed to move the drive 38. Many drives 38 allow the magnetic induction heater 10 to be used in remote areas without access to electricity.

The shuttering device 30 can include a drive shaft 40 for rotational movement, as seen in FIGS. 1 and 2, but other drive options are also possible. For example, the shuttering device 30 could be belt driven, as seen in FIG. 4. The shuttering device 30 could be driven by a gear system, or a cam system, or any of a wide variety of drive options.

The magnetic induction heater 10 can include a controller 42 in some embodiments. The controller 42 can perform a wide variety of tasks, including controlling the drive speed, controlling the voltage or current to the magnetic coils 22 or the blocking coils 36, or controlling other components of the heater 10. A temperature element 44 can sense the temperature and relay the information to the controller 42, and the controller 42 can use this temperature to set operating conditions. The temperature element 44 can be positioned in the heater discharge, or in a living space being heated, or near the target, or at any of a wide variety of other locations. There can be more than one temperature element 44 which can read the temperature at different locations, or provide redundant readings at essentially the same location for quality control purposes.

A temperature element 44 can be included in the body of the magnetic induction heater 10 as a safety option to prevent fires, or to ensure the Curie temperature of the magnets is not exceeded. The magnetic induction heater 10 can include other sensors as well, such as hot or cold air flow sensors, voltage or current sensors, magnetic field sensors, or other sensors which may increase safety, improve operations, prevent de-magnetization of the magnets, or simply provide operational data. All the sensors can be tied to the controller 42, but it is also possible to have direct readouts that are not tied to the controller 42.

In some embodiments, the controller 42 can increase or decrease the drive rate for the shuttering device 30, so the rate of change of the induced magnetic field in the target 12 is changed. The change of rate for the drive 38 can therefore control the heat output of the magnetic induction heater 10. The controller can also change voltages or current to the magnet coil 22 or the blocking coil 36 as an alternate method of controlling the heat output of the heater 10. It is also possible to operate the magnetic induction heater 10 without a controller, if desired.

### Heat Transfer System

The magnetic induction heater 10 can also include a heat transfer system 50. The heat transfer system 50 can facilitate heat transfer from the target 12 to a desired area or object. In some embodiments, the heat transfer system 50 will include a fan 52, where the term “fan” is defined to include fans, blowers, or other devices that mechanically move air. The fan 52 can push or pull air past the target 12 itself, or the target 12 can be connected to a heat exchanger with a conductive attachment 56. The fan 52 can be built into the shuttering device 30, as seen in FIG. 4, or the fan 52 can have a separate drive. It is also possible for the fan 52 and the shuttering device 30 to have a common drive 38, with a belt, gears, or other mechanisms to connect the various components.

The conductive attachment 56 can be a strip of conductive metal that connects the target 12 to heat transfer elements in the heat exchanger. The conductive attachment 56 can also be a liquid heat transfer system, where the target heats a liquid which then transfers the heat to a heat exchanger. The target 12 or components in the heat exchanger can include fins 58 or other surface enhancements to increase heat transfer rates, as desired.

There are many embodiments of heat transfer systems 50 to transfer heat from the target 12 to a desired location. In some embodiments, the magnetic inductive heater 10 can be used to heat specific objects, such as electrical boards for soldering, pots for cooking, or many other options. The target 12 can then be conductively connected to the article to be heated, but it is also possible to heat various articles with convective heat or even radiant heat, as desired. The magnetic induction heater 10 can also be used to heat a living space, or used to provide heat for a wide variety of purposes.

While the invention has been described with respect to a limited number of embodiments, those skilled in the art, having the benefit of this disclosure, will appreciate that other embodiments can be devised which do not depart from the scope of the invention as disclosed here. Accordingly, the scope of the invention should be limited only by the attached claims.

1. A magnetic induction heating device comprising:
a stationary target;
a first magnet positioned near the target such that the first magnet induces a first magnetic field in the target, where the first magnet is stationary and has fixed poles;
a second magnet positioned near the target such that the second magnet induces a second magnetic field in the target, where the second magnetic field is different than the first magnetic field, and where the second magnet is stationary and has fixed poles,
a shuttering device positioned between the target and the first magnet, where the shuttering device alternates between a passing position in which the first magnetic field is exposed to the target and a blocking position in which the exposure of the first magnetic field to the target is less than in the passing position.

2. The heating device of claim 1 where the target is non-ferrous.

3. The heating device of claim 1 where the shuttering device is a coil of wire.

4. The heating device of claim 1 where the shuttering device is a physical barrier between the magnet and the target, and where the shuttering device moves relative to the target and the magnets.

5. The heating device of claim 4 where the shuttering device comprises a ferromagnetic material.

6. The heating device of claim 4 further comprising a drive connected to the shuttering device, where the drive moves the shuttering device relative to the target and the magnets.

7. The heating device of claim 1 further comprising a heat transfer system.

8. The heating device of claim 7 where the heat transfer system further comprises a conductive attachment connected to the target, and a fan positioned to blow across the conductive attachment.

9. A magnetic induction heating device comprising:
a stationary target;
a first electromagnet fixedly positioned near the target such that the first electromagnet induces a first magnetic field in the target, and where the first electromagnet comprises a first coil;
a second electromagnet fixedly positioned near the target such that the second electromagnet induces a second magnetic field in the target, and where the second magnetic field induced in the target is different than the first magnetic field induced in the target, and where the second electromagnet comprises a second coil; and
at least one switch connected to a direct current electricity supply and to the coils, where the at least one switch is configured to alternately supply direct current to the first and second electromagnets.

10. The heating device of claim 9 further comprising a controller that operates the switch.

12. The heating device of claim 9 where the first electromagnet comprises at least two electromagnets, and where the switch opens direct current to the at least two first electromagnets at the same time.

13. The heating device of claim 9 further comprising a third electromagnet fixedly positioned near the target such that the third electromagnet induces a third magnetic field in the target, and where the third magnetic field is different than either of the first and second magnetic fields.

14. The heating device of claim 9 further comprising a heat transfer system.

15. The heating device of claim 14 further comprising a conductive attachment connected to the target, and a fan positioned to blow across the conductive attachment.

16. A method of producing heat comprising:
(a) providing a stationary target;
(b) positioning a first magnet having fixed poles near the target such that the first magnet induces a magnetic field in the target, and where the first magnet is in a fixed position relative to the target;
(c) positioning a second magnet having fixed poles near the target such that the second magnet induces a magnetic field in the target, where the magnetic fields induced in the target by the first and second magnets are different, and where the second magnet is in a fixed position relative to the target;
(d) shuttering and alternately exposing the target from the magnetic field induced by the first magnet; and
(e) shuttering and alternately exposing the target from the magnetic field induced by the second magnet.

17. The method of claim 16 where the target is exposed to only one of the first and second magnets at one time.

18. The method of claim 16 where (d) and (e) further comprise moving a shuttering device relative to the target and the first and second magnets such that the shuttering device alternately exposes the target to the first and second magnets.

19. The method of claim 16 where (d) and (e) further comprise electronically shuttering the target from the first and second magnets.

20. The method of claim 16 further comprising conducting heat from the target to a heat exchanger, and blowing air through the heat exchanger.

21. The method of claim 20 where a conductive attachment is connected to the target to conduct heat from the target to the heat exchanger.
